(19) United States
(12) Patent Application Publication
(10) Pub. No.: US 2016/0366688 A1
(43) Pub. Date: Dec. 15, 2016

(54) OPTIMIZING WIRELESS NETWORK COMMUNICATIONS

(71) Applicants: Xiaogang Chen, Beijing (CN); Qinghua Li, San Ramon, CA (US); Yuan Zhu, Beijing (CN); Yushu Zhang, Beijing (CN)

(72) Inventors: Xiaogang Chen, Beijing (CN); Qinghua Li, San Ramon, CA (US); Yuan Zhu, Beijing (CN); Yushu Zhang, Beijing (CN)

(21) Appl. No.: 14/871,500

(22) Filed: Sep. 30, 2015

Related U.S. Application Data
(60) Provisional application No. 62/173,803, filed on Jun. 10, 2015.

(51) Int. Cl. H04W 72/04; H04B 7/04; H04W 72/08

(52) U.S. Cl. CPC H04W 72/0453; H04W 72/082; H04B 7/0452

(57) ABSTRACT

Provided are systems for selecting a frequency resource allocation index that allocates a first resource unit (RU) utilized in a narrow bandwidth transmission, setting a second RU in the frequency resource allocation index as non-allocated, and receiving a stream index of a multiple-user multiple-input multiple-output (MU-MIMO) transmission, the stream index including a spatial stream indication for a station (STA) and an indication of a number of high-efficiency long training field (HE-LTF) symbols in a current PLCP Protocol Data Unit (PPDU).

### CROSS-REFERENCE TO RELATED APPLICATIONS

This application claims priority to and benefit of U.S. Patent Application Ser. No. 62/173,803 filed on Jun. 10, 2015, and entitled “Partial Resource Unit Allocation Pattern.” The disclosure of the aforementioned application is entirely incorporated herein by reference.

### TECHNICAL FIELD

This disclosure generally relates to systems and methods for wireless communications and, more particularly, to optimizing wireless communications technologies.

### BACKGROUND

Wireless devices are becoming widely prevalent and are increasingly requesting access to wireless channels. A next generation WLAN, IEEE 802.11ax or High-Efficiency WLAN (HEW), is under development.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 depicts a network diagram illustrating an example network environment of an illustrative wireless communication system, according to one or more example embodiments of the disclosure;

FIGS. 2A-2D depict several example entries for a long range resource unit, according to one or more example embodiments of the disclosure;

FIG. 3 depicts example non-allocated resource units for frequency domain interference mitigation, according to one or more example embodiments of the disclosure;

FIG. 4 depicts example contiguous and distributed non-allocated resource units, according to one or more example embodiments of the disclosure;

FIG. 5 depicts an example stream index table if a maximum of four streams are supported per wireless station, according to one or more example embodiments of the disclosure;

FIG. 6 depicts an example stream index table if a maximum of eight streams are supported per wireless station, according to one or more example embodiments of the disclosure;

FIG. 7 depicts a second example stream index table if a maximum of eight streams are supported per wireless station, according to one or more example embodiments of the disclosure;

FIG. 8A depicts an exemplary process flow for allocating resource units (RUs) utilized in a narrow bandwidth transmission, according to one or more example embodiments of the disclosure;

FIG. 8B depicts an exemplary process flow for optimizing a spatial stream indication for a station (STA) and indicating a number of long training field (LTF) symbols in a PLCP Protocol Data Unit (PPDU), according to one or more example embodiments of the disclosure;

FIG. 9 illustrates a functional diagram of an example access point or example wireless station, according to one or more example embodiments of the disclosure; and

FIG. 10 shows a block diagram of an example of a machine upon which any of one or more techniques (e.g., methods) according to one or more embodiments of the disclosure discussed herein may be performed.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Example embodiments described herein provide certain systems, methods, and devices, for providing signaling information to Wi-Fi devices in various Wi-Fi networks. As such, Wi-Fi-enabled devices in various Wi-Fi networks, including, but not limited to, IEEE 802.11ax, may utilize embodiments described herein.

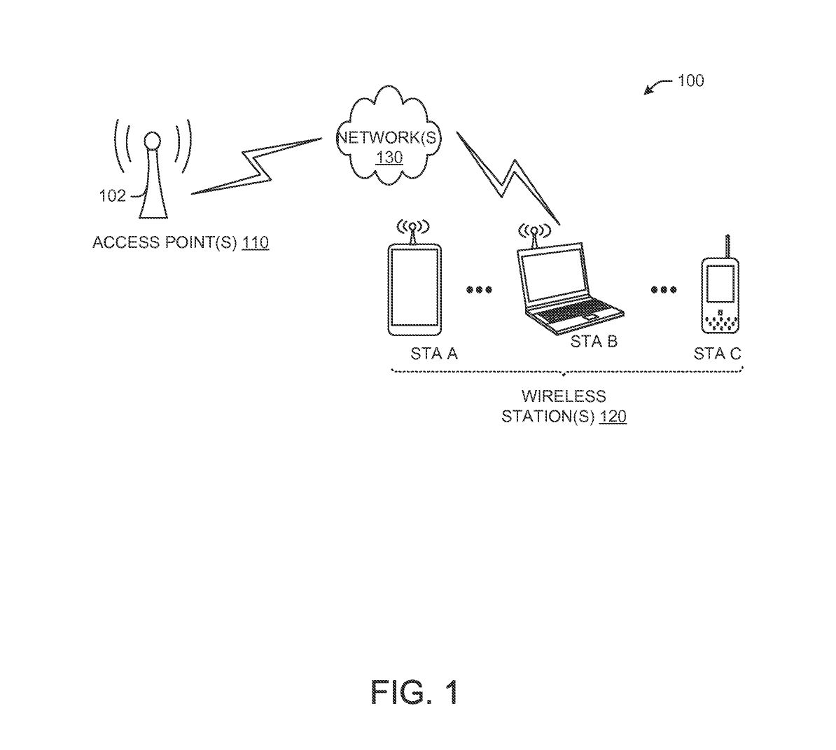

Referring now to the drawings, FIG. 1 illustrates a wireless communication system 100 in accordance with one or more embodiments of the disclosure. For example, the wireless communication system 100 may comprise one or more access points 110 and/or one or more wireless stations 120. Typically, the one or more access points 110 communicate with the one or more wireless stations 120 over one or more networks 130.

In some embodiments, the one or more access points 110 may be operable by and/or associated with one or more service providers such as a cable company, a fiber company, a wireless network provider, an Internet provider, a Wi-Fi hotspot operator, a home owner, a network administrator, and/or the like. Typically, the one or more access points 110 provide access to the Internet or other wireless network, and/or the like.

The one or more access points 110 may include any suitable processor-driven device including, but not limited to, a mainframe server, a hard drive, a desktop computing device, a laptop computing device, a router, a repeater, a switch, a smartphone, a tablet, a wearable wireless device (e.g., a bracelet, a watch, glasses, a ring, an implant, and/or the like) and/or so forth. For example, the one or more access points 110 may embody computing device 1910 of FIG. 19, computing device 2010 of FIG. 20, computing device 2100 of FIG. 21, and/or the like. The term “access point” (AP) (e.g., access point(s) 110) as used herein may be a fixed station. An access point 110 may also be referred to as an access node, a base station or some other similar terminology known in the art. An access point 110 may also be called a mobile station, user equipment (UE), a wireless communication device or some other similar terminology known in the art.

The one or more wireless stations 120 (STAs) may be operable by one or more respective users (e.g., subscribers, viewers, customers, consumers, operators, administrators, agents, and/or the like) of the one or more wireless stations. For example, the one or more wireless stations 120 may be associated with subscribers of an Internet services provided by the one or more access points 110. In some embodiments, users of the one or more wireless stations 120 may enter and/or have entered an agreement with a service provider associated with the one or more access points 110 to receive access to a service (e.g., wireless Internet access) provided by the service provider via the one or more access points 110 (and/or a secure enclave of the one or more access points 110) to the one or more wireless stations 120 based at least in part on the agreement.

The wireless station(s) 120 may include any suitable processor-driven user device including, but not limited to, a desktop computing device, a laptop computing device, a server, a router, a switch, a smartphone, a tablet, wearable wireless device (e.g., bracelet, watch, glasses, ring, implant, etc.) and so forth. For example, the one or more wireless stations 120 may embody computing device 1910 of FIG. 19, computing device 2010 of FIG. 20, computing device 2100 of FIG. 21, and/or the like. Alternatively, the one or more wireless stations 120 may be routers, repeaters, and/or any other type of networking hardware.

Any of the access points 110 and/or the wireless station(s) 120 may be configured to communicate with each other and any other component of the wireless communication system 100 via one or more communications networks (e.g., networks 130). Any of the communications networks 130 may include, but are not limited to any one or a combination of different types of suitable communications networks such as, for example, broadcasting networks, cable networks, public networks (e.g., the Internet), private networks, wireless networks, cellular networks, or any other suitable private and/or public networks. Further, any of the communications networks 130 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

The one or more access points 110 may communicate with the one or more wireless stations 120 (e.g., data, content, and/or the like may be transmitted, retrieved, and/or received between the one or more access points 110 and/or the one or more wireless stations 120). Additionally, the one or more wireless stations 120 may communicate with one or more other wireless stations 120. As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit (e.g., an access point 110), which is capable of communicating a wireless communication signal, may include a wireless transmitter to transmit the wireless communication signal to at least one other wireless communication unit (e.g., a wireless station 120), and/or a wireless communication receiver to receive the wireless communication signal from at least one other wireless communication unit.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Orthogonal Frequency-Division Multiple Access (OFDMA), Radio Frequency (RF), Infra-Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Further, any of the one or more access points 110 and/or the one or more wireless stations 120 may include one or more communications antennae. Communications antenna may be any suitable type of antenna corresponding to the communications protocols used by the one or more access points 110 and/or the one or more wireless stations 120. Some non-limiting examples of suitable communications antennas include WiFi antennas, IEEE 802.11 family of standards compatible antennas, directional antennas, non-directional antennas, dipole antennas, folded dipole antennas, patch antennas, MIMO antennas, or the like. The communications antenna may be communicatively coupled to a radio component to transmit and/or receive signals, such as communications signals to and/or from the one or more access points 110 and/or the one or more wireless stations 120. Any of the one or more access points 110 and/or the one or more wireless stations 120 may include any suitable radio and/or transceiver for transmitting and/or receiving radio frequency (RF) signals in the bandwidth and/or channels corresponding to the communications protocols utilized by any of the one or more access points 110 and/or the one or more wireless stations 120 to communicate with each other. The radio components may include hardware and/or software to modulate and/or demodulate communications signals according to pre-established transmission protocols. The radio components may further have hardware and/or software instructions to communicate via one or more WiFi and/or WiFi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad) or any other 802.11 type channels (e.g., 802.11ax). In some embodiments, non-WiFi protocols may be used for communications between devices, such as Bluetooth, dedicated short-range communication (DSRC), Ultra-High Frequency (UHF), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In a wireless connection between the one or more access points 110 and/or the one or more wireless stations 120, a direction of data from the one or more access points 110 to the one or more wireless stations 120 may be referred to as downlink direction. Conversely, an uplink connection may be used to send data from the one or more wireless stations 120 back to the one or more access points 110. Typically, when the one or more access points 110 establishes communication with the one or more wireless stations 120, the one or more access points 110 may communicate in the downlink direction by sending data packets to the one or more wireless stations 120. The data packets may be preceded by one or more preambles that may be part of one or more headers. These preambles may be read by the one or more wireless stations 120 and used to allow the one or more wireless stations 120 to detect incoming data packets (e.g., video content, associated information, and/or the like) from the one or more access points 110. In some embodiments, the preambles may be a signal, an identifier, and/or the like used in network communications to synchronize transmission timing between two or more devices (e.g., between the one or more access points 110 and/or the one or more wireless stations 120). The length of each preamble may affect the time required to transmit data between devices, which in turn may increase data packet overhead. The same functionality may enable multiple wireless stations 120 to communicate with each other.

In some embodiments, uplink and/or downlink data packet formats may follow one of the IEEE standards, (e.g., IEEE 802.11ac). For example, an uplink and/or downlink data packet may contain a legacy preamble that may be compatible with legacy standards such as 802.11. The downlink data packet may also contain a very high throughput (VHT) preamble that may contain a number of timeslots that may have a certain time duration and that may contain various fields that may follow one or more IEEE standards (e.g., 802.11ac).

In some embodiments, channel or stream training may be needed to allow a receiver of the data packets (e.g., the one or more wireless stations 120) to properly synchronize with the transmitter of the data packets (e.g., the one or more access points 110, a second wireless station 120, and/or the like). For example, in the downlink direction from the one or more access points 110 to the one or more wireless stations 120, the one or more access points 110 may transmit a channel training symbol or a training field that may be used to train (e.g., synchronize) the one or more wireless stations 120 with the one or more access points 110 to accurately and consistently send and receive data to and from the one or more access points 110.

Multi-user multiple-input multiple-output antenna system (MU-MIMO) may provide an enhancement for the IEEE 802.11 family of standards. With MU-MIMO, multiple wireless stations 120 may be served at the same time by the one or more access points 110. Some of the IEEE 802.11 standards (e.g., IEEE 802.11ax) may use OFDMA (orthogonal frequency-division multiple access) to carry the data the one or more access points 110 may transmit. Like OFDM (orthogonal frequency-division multiplexing), OFDMA encodes data on multiple sub-carrier frequencies. It is understood that OFDMA is a multi-user version of OFDM digital modulation scheme. Multiple access may be achieved in OFDMA by assigning subsets of subcarriers to individual users and/or wireless stations 120, which may allow simultaneous data rate transmission from several users and/or wireless stations 120. For example, multiple access methods may allow several wireless stations 120 that may be connected to the same access point 104 to transmit and receive over it and to share its capacity.

Beamforming or spatial filtering is a signal processing technique used in sensor arrays for directional signal transmission or reception. Beamforming may be used at both the transmitting and receiving ends of the one or more access points 110 and/or the one or more wireless stations 120 in order to achieve spatial selectivity. It is understood that beamforming may be used for radio or sound waves. Beamforming may be found in applications such as radar, sonar, seismology, wireless communications, radio astronomy, acoustics, and biomedicine. In some embodiments, crosstalk between different communications channels (e.g., signal distortion) may be mitigated by transmitting additional training fields that may exist between communication channels.

In some instances, a transmitter, such as the one or more access points 110, may transmit a trigger frame (e.g., a data packet, a training field, a channel training symbol, and/or the like) to the one or more wireless stations 120. The trigger frame may be sent periodically and/or continuously and may include scheduling information for frequency, subband, and/or spatial stream designations for respective wireless stations 120 in communication with the one or more access points 110. In some embodiments, each wireless station 120 may be designated a particular frequency and/or subband for communication with the one or more access points 110. Alternatively, each wireless station 120 may be designated a frequency and/or subband that is dynamic and therefore may change depending on particular conditions (e.g., current traffic, measured distortion, predicted traffic, and/or the like). The one or more wireless stations 120 may use information provided in the trigger frame (or in a header of the trigger frame) to synchronize with the one or more access points 110. Communication between each wireless station 120 and/or the one or more access points 110 typically occurs over one or more channels (e.g., streams of data).

In accordance with some IEEE 802.11ax (High-Efficiency WLAN (HEW)) embodiments, an access point may operate as a master station which may be arranged to contend for a wireless medium (e.g., during a contention period) to receive exclusive control of the medium for an HEW control period. The master station may transmit an HEW master-sync transmission at the beginning of the HEW control period. During the HEW control period, HEW stations may communicate with the master station in accordance with a non-contention based multiple access technique. This is unlike conventional Wi-Fi communications in which devices communicate in accordance with a contention-based communication technique, rather than a multiple access technique. During the HEW control period, the master station may communicate with HEW stations using one or more HEW frames. Furthermore, during the HEW control period, legacy stations refrain from communicating. In some embodiments, the master-sync transmission may be referred to as an HEW control and schedule transmission.

In some embodiments, the multiple-access technique used during the HEW control period may be a scheduled orthogonal frequency division multiple access (OFDMA) technique, although this is not a requirement. In other embodiments, the multiple access technique may be a time-division multiple access (TDMA) technique or a frequency division multiple access (FDMA) technique. In certain embodiments, the multiple access technique may be a space-division multiple access (SDMA) technique.

The master station may also communicate with legacy stations in accordance with legacy IEEE 802.11 communication techniques. In some embodiments, the master station may also be configurable to communicate with HEW stations outside the HEW control period in accordance with legacy IEEE 802.11 communication techniques, although this is not a requirement.

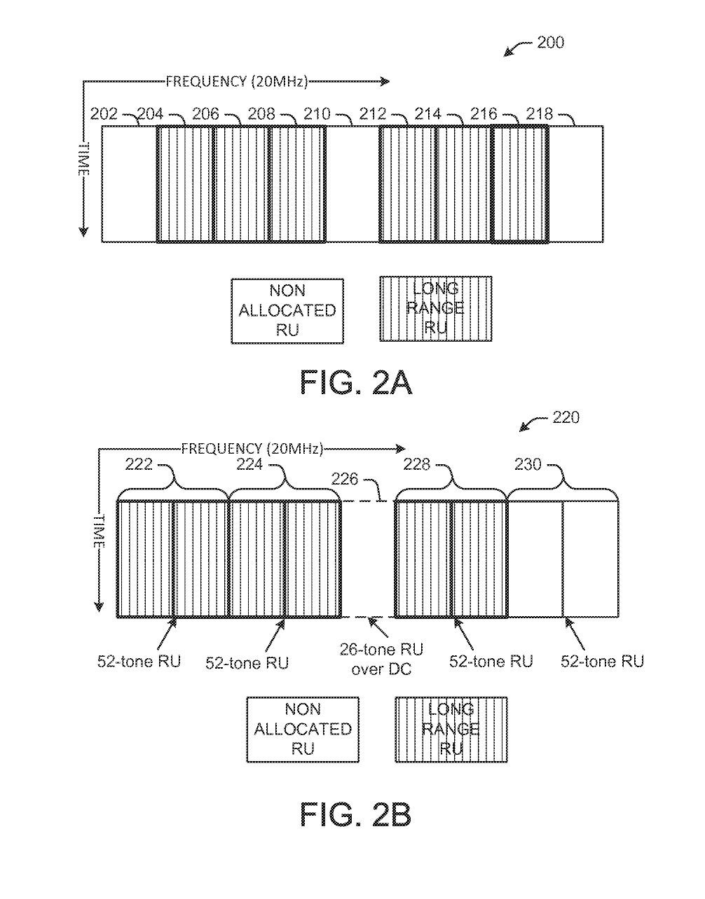

FIG. 2A depicts an example entry 200 for a long range resource unit, according to one or more example embodiments of the disclosure. Some 802.11ax devices support long range DL/UL transmission in outdoor modes. For such scenario, reliable reception is more desirable than high throughput. Accordingly, 802.11ax devices may want to transmit on a narrower bandwidth (e.g., a 26-tone resource unit (RU) or a 52-tone RU) to gain stronger transmission power spectrum density. Therefore, it may be necessary to define additional entries in a frequency partition indexing scheme for use in a high-efficiency signal field B (HE-SIG-B) portion of a physical layer header. The entry 200 indicates that a 26-tone resource RU is used in a current PLCP Protocol Data Unit (PPDU) for long range transmission, and that other RUs are unallocated or unused. Note that the above described method may be easily extended to more entries, which are used to allocate narrow bandwidth RUs for long range transmissions across 20 MHz. For example, there are 7 indexes left in FIG. 2 for 8 index bits supporting 256 indexes. Since RUs close to DC power and band edge are usually undesirable due to interferences, 6 out of the 7 remaining indexes may be used to allocate one 26-tone RU out to the 6 desirable 26-tone RUs (e.g., RUs 204, 206, 208, 212, 214, 216 and 218) in FIG. 2 counting from the left to the right.

FIG. 2B depicts an example entry 220 for a long range resource unit, according to one or more example embodiments of the disclosure. As shown in FIG. 2B, four 52-tone RUs 222, 224, 228 and 230 are in a 20 MHz channel. One of the RUs may be used for long range transmissions. The two 52-tone RUs 222 and 230 are located at the edges of a channel and thus are vulnerable to interference. The remaining two 52-tone RUs 224 and 228 are away from the DC tone in RU 226 because RU 226 is a 26-tone RU straddling the DC tone thereby making the two 52-tone RUs 224 and 228 in the middle of the channel desirable. In some embodiments, either the RU 224 or the RU 228 may be used for long range applications.

FIG. 2C depicts an example entry 240 for a long range resource unit, according to one or more example embodiments of the disclosure. As shown in FIG. 2C, four 52-tone RUs 242, 244, 248 and 250 are in a 20 MHz channel and one 26-tone RU 246 is also in the same channel. One of the RUs (e.g, the RU 244) may be used for long range transmissions. The two 52-tone RUs 242 and 250 are located at the edges of a channel and thus are vulnerable to interference. The remaining two 52-tone RUs 244 and 248 are away from the DC tone in RU 246 because RU 246 is a 26-tone RU straddling the DC tone thereby making the two 52-tone RUs 244 and 248 in the middle of the channel desirable. In some embodiments, either the RU 244 or the RU 248 may be used for long range applications.

It should be appreciated that in accordance with some embodiments, one resource allocation index may indicate that a 26-tone RU of the available 6 RUs in FIG. 2A is allocated to a user and another resource allocation index may indicate that a 52-tone RU of the available 2 RUs in FIG. 2C is allocated to a user. Thus, it should be understood that two resource allocation indexes may be used for long range applications in some embodiments.

For non-long range applications, an AP may need to exclude one or two RUs in some cases. For example, the middle 26-tone RU close to DC power may be left unused when there are only two STAs in the system. Therefore, the remaining indexes may be used to indicate bandwidth allocation patterns that one or two RUs are left unused (e.g. the middle 26-tone RU or the edge 26-tone RU).

It should be understood that besides the partial RU allocations described above with respect to FIGS. 2A-2C, a completely null allocation may also be useful for non-long range applications. For example, an AP may use a channel wider than 20 MHz in some embodiments. In this case, the HE-SIG-B field may be divided into two or more subfields e.g. HE-SIG-B1 and HE-SIG-B2. The channel may be also divided into two or more subsets (or sub-channel groups). Each subfield may be responsible for the resource allocation of one subset. For example, an HE-SIG-B1 field may be responsible for allocating a 40 MHz or 20 MHz subset of an 80 MHz channel and an HE-SIG-B2 field may be responsible for allocating the rest. Some RUs in the channel may straddle two subsets (or sub-channel groups). Namely, one part of an RU may be in one subset and the other part of the RU may be in the other subset. In some embodiments, the resource allocation of a straddling RU may be done by one of the subfields responsible for one of the two subsets that the RU straddles. For reducing the resource allocation overhead, such as partial access ID (PAID) and modulation coding scheme (MCS), the other subfield responsible for the subset that the straddling RU straddles may not repeat the resource allocation of the straddling RU. In that subfield, a special index (e.g. a null index having all ones or all zeros) may be used. The special index indicates that the part of the RU in the subset responsible by the subfield is not allocated by the subfield.

For example, FIG. 2D shows an 80 MHz channel that is divided into two subsets 280 and 282. The subset 280 may include RUs 262 and 268 while the subset 282 may include RUs 264 and 270. A middle 26-tone RU 266 may be in either of the subsets 280 or 282. A 484-tone RU 284 (which may have 480-489 tones) straddles the two subsets 280 and 282. In some embodiments, an HE-SIG-B1 subfield may be responsible for the subset 280 and an HE-SIG-B2 subfield may be responsible for the subset 282. The straddling 484-tone RU 284 may be allocated by either of the subfields responsible for subsets 280 and 282, respectively. When an HE-SIG-B1 subfield allocates the straddling 484-tone RU 284 to a user, a portion of the RU 284 (i.e., about 242 subcarriers) located in the subset 282 (e.g. 264) does not need to be allocated again to the same user. Therefore, the HE-SIG-B2 subfield may use a null resource allocation index (e.g., 00000000 or 11111111) for a portion of the RU 284. As a result, the HE-SIG-B2 subfield doesn't need to further specify the PAID or the MCS for the aforementioned portion of the RU 284. It should be understood that when a receiver reads the null index, the receiver knows that the subfield carrying the index does not allocate the corresponding portion of the subcarriers and that the portion of the subcarriers may be allocated by another subfield or not allocated at all.

In some embodiments, RUs may not be fully utilized across the entire bandwidth considering frequency domain interference mitigation in Overlapping Basic Service Sets (OBSSs). For example, in order to support high density deployment in 802.11ax, frequency domain interference mitigation may be applied if neighboring APs know (e.g., can determine) and/or can measure interference across the whole bandwidth.

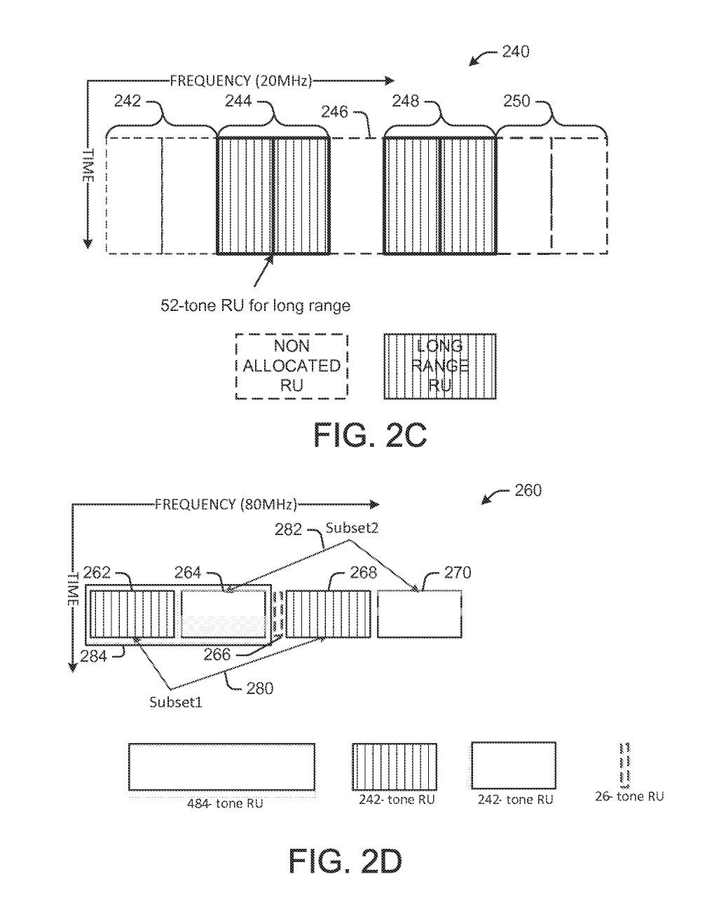

As shown in exemplary environment 300 of FIG. 3, the transmission on RUs 1,2,6,7,8,9 in AP1 302 may interfere with the corresponding RUs in AP2 304; and the transmission on RUs 3,4,5 in AP2 304 may interfere with the corresponding RUs in AP1 302.

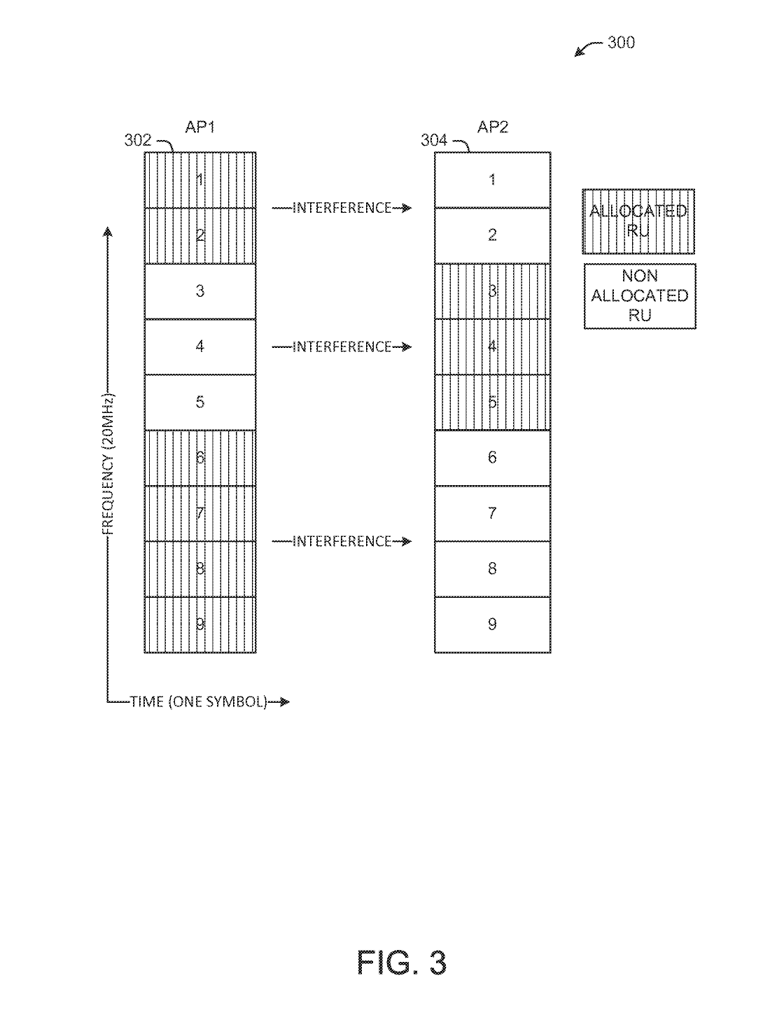

In order to overcome the aforementioned scenario, some entries may need to be defined such that several RUs are non-allocated across the whole bandwidth to mitigate the interference. As such, the non-allocated RUs can be contiguously RUs or distributed RUs. An example of continuous and distributed non-allocated RUs is shown as being associated with APs 402 and 404, respectively, in the exemplary environment 400 of FIG. 4.

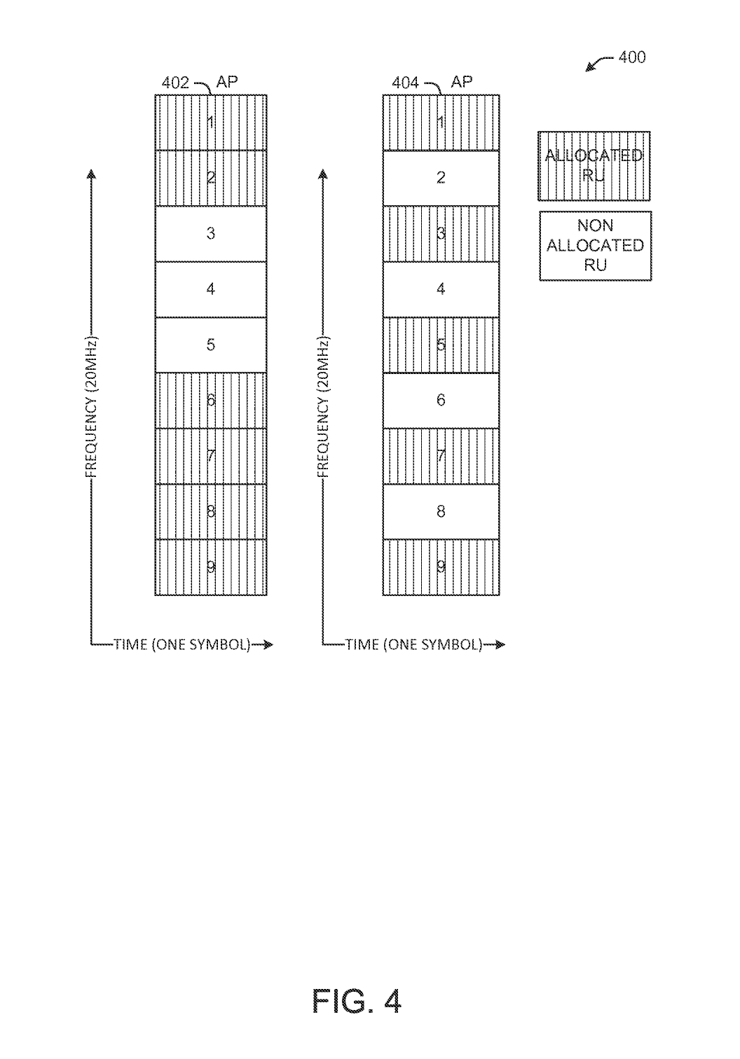

In some embodiments, a spatial indication table may be optimized to save one bit utilized for signaling. For example, 5 bits (e.g., 3 bits for a start stream index+2 bits for the number of streams) may be utilized for spatial stream indication. An assumption in this example may be that the maximum number of streams for MU-MIMO transmissions is 4 streams per STA because only 2 bits may be allocated for a stream index. Given this assumption, the stream index for each STA can be indicated in the table 500 in FIG. 5. For MU-MIMO transmissions, if the maximum number of streams for each STA is up to 4, table 500 may be simplified to fit all entries into 4 bits (as shown in rows 502-508). Thus, the strikethrough entries in rows 510-516 in the table 500 may be removed to decrease the total number of entries to be 16. As a result, 4 bits may be used for the stream index instead of 5 bits.

In some embodiments, the indication of the number of high-efficiency long training field (HE-LTF) symbols may be optimized to save one bit. For example, in channel estimation, 802.11ax devices only need to consider 1/2/4/6/8 HE-LTF symbols for time domain de-spreading because of corresponding P-matrix sizes of 1/2/4/6/8. As such, 3 bits may be utilized to indicate 5 numbers of HE-LTF symbols, and thus 3 entries may be wasted.

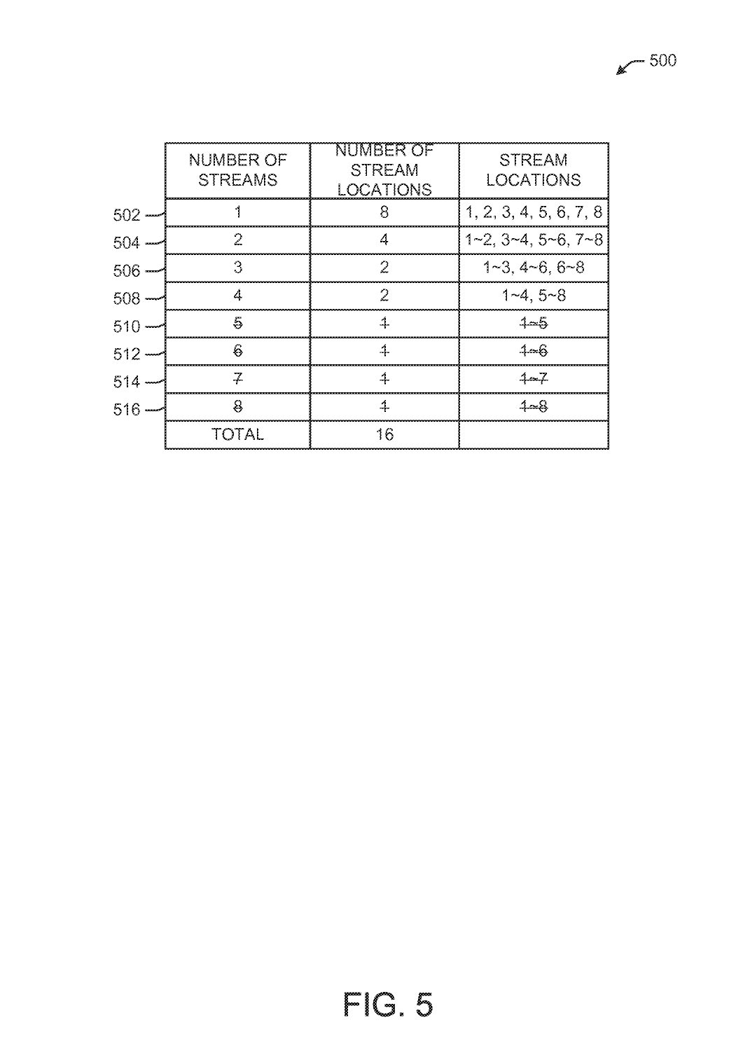

Accordingly, table 500 of FIG. 5 may be modified to table 600 shown in FIG. 6. In particular, one entry may be added to rows 602-616 (i.e., row 618) to indicate that there is only one HE-LTF symbol in the current PPDU. Then 2 bits may be used in the common part of HE-SIG-B to indicate 2/4/6/8 HE-LTFs in the current PPDU. For example, index 00 in the common part may indicate either 1 or 2 HE-LTF symbols. If row 618 in table 600 is indicated in the user specific part, 1 HE-LTF symbol is indicated; otherwise, 2 HE-LTF symbols are indicated. After a STA decodes the 2 bits in the common part of HE-SIG-B and the stream index in table 600 (e.g., in the STA specific part of HE-SIG-B), the STA may determine an exact number of HE-LTF symbols in the current PPDU.

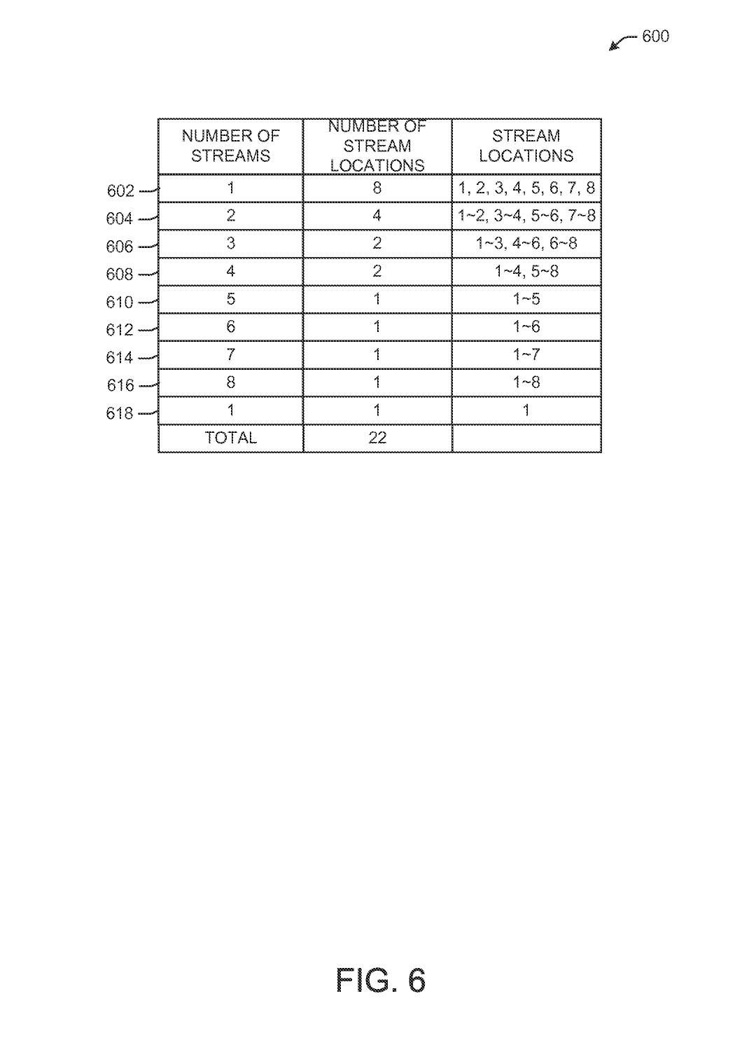

It should be understood that the concepts described above may be extended. For example, there are 10 unused indexes in table 600. These 10 indexes may be used to indicate a total number of HE-LTF symbols equal to 2 as shown in table 700 of FIG. 7 (e.g., the indexes shown in rows 718-722). Table 700 also shows additional entries in rows 702-716 which are not utilized to indicate HE-LTF symbols.

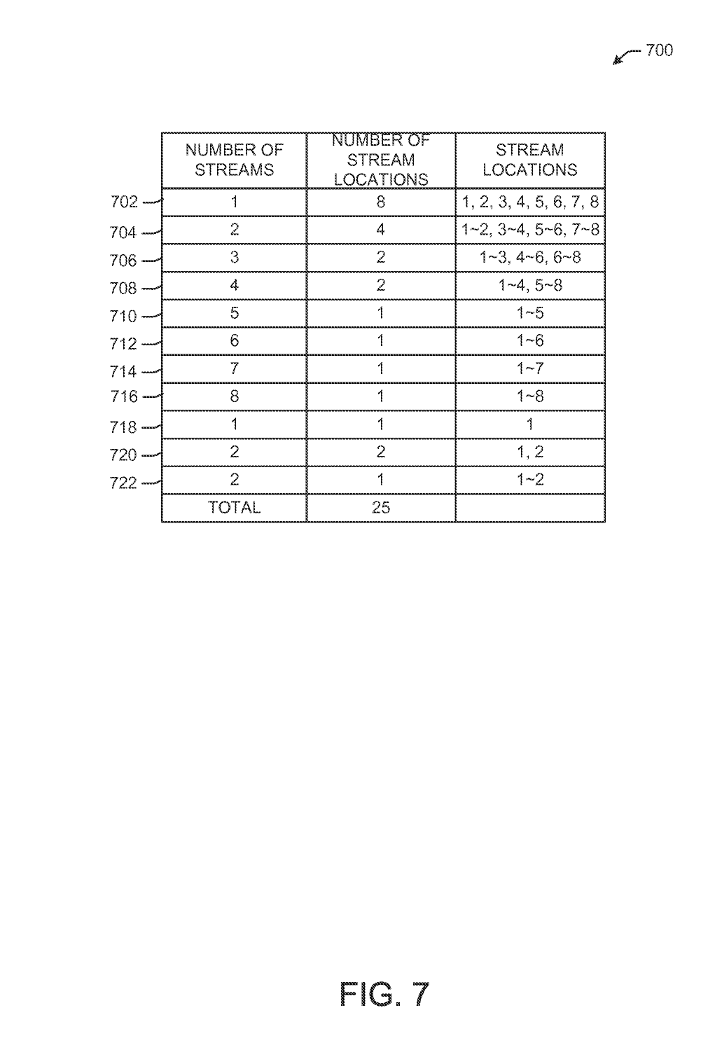

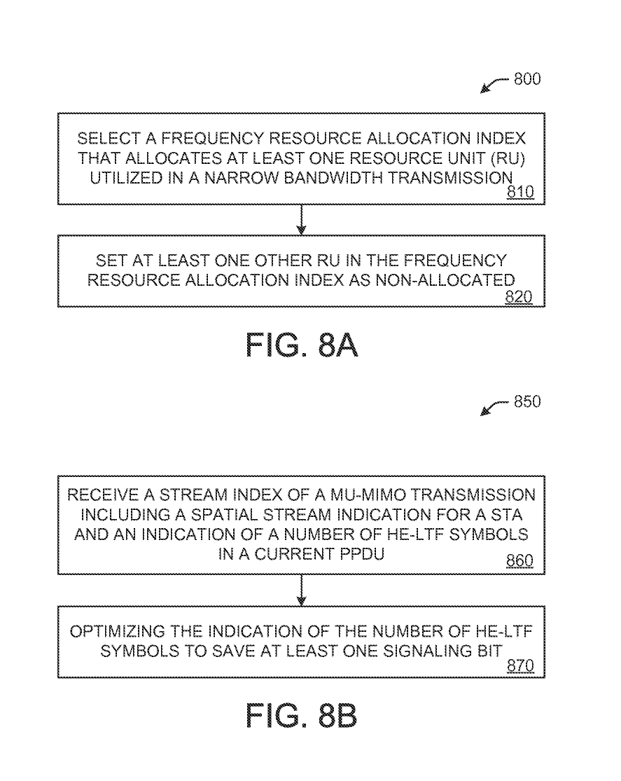

FIG. 8A illustrates an example process flow 800 for allocating RUs utilized in a narrow bandwidth transmission. At block 810, the process includes selecting a frequency resource allocation index that allocates at least one RU utilized in a narrow bandwidth transmission. At block 820, the process includes setting at least one other RU in the frequency resource allocation index as non-allocated. In some embodiments, the transmission may include a HE-SIG-B communication and the allocated RU may be a 26-tone RU. In some embodiments, the non-allocated RUs may be arranged contiguously in the frequency partition index to mitigate frequency domain interference. In some embodiments, the non-allocated RUs may be arranged non-contiguously in the frequency resource allocation index to mitigate frequency domain interference. In some embodiments, the HE-SIG-B communication may include a HE-SIG-B1 communication and a HE-SIG-B2 communication. The HE-SIG-B2 communication may allocate a 20 MHZ sub channel in instead of the HE-SIG-B1 communication allocating the 20 MHZ sub channel.

FIG. 8B illustrates an example process flow 850 for optimizing a spatial stream indication for a STA and indicating a number of HE-LTF symbols in a PPDU. At block 860, the process includes receiving a stream index of a MU-MIMO transmission. The stream index may include both a spatial stream indication for a station (STA) and an indication of a number of high-efficiency long training field (HE-LTF) symbols in a current PLCP Protocol Data Unit (PPDU). At block 870, the process includes optimizing the indication of the number of HE-LTF symbols to save one signaling bit. For example, the indication of the number of HE-LTF symbols is optimized by limiting a number of MU-MIMO user spatial streams to reduce signaling overhead. In particular, in MU-MIMO, because multiple users, each with one or more antenna(s) are involved, the maximum number of spatial streams per user doesn't need to be the same as for a single user case. Namely, as long as the total number of streams from all MU-MIMO users reaches the capacity of a base station (e.g., 8 streams), there should be no throughput performance loss. As shown in FIG. 5, the number of spatial streams of each MU-MIMO user is limited to 4 so that only 4 bits (instead of 5 bits) are enough for specifying the stream allocation. Thus, by limiting the number of spatial streams per user in MU-MIMO, one can reduce the signaling overhead without losing throughput performance. If the maximum number of spatial streams for each MU-MIMO user is not limited to 4, 5 bits are needed for stream allocation. If 5 bits are used, and the maximum number of streams is 8, there are unused entries. The unused entries can be utilized to specify the number of HE-LTF symbols. In FIG. 6, entry 618 indicates the case that there is only one HE-LTF symbol and one spatial stream allocated. In FIG. 7, four entries in 718, 720, and 722 indicate three cases. Entry 718 indicates that there is one HE-LTF symbol and one spatial stream allocated. Entry 720 indicates that there are two HE-LTF symbols and one of the two spatial streams (i.e., stream 1 or stream 2) is allocated, respectively. Entry 722 indicates that there are two HE-LTF symbols and both spatial streams are allocated. In contrast, entries 702-716 do not explicitly specify a number of HE-LTF symbols.

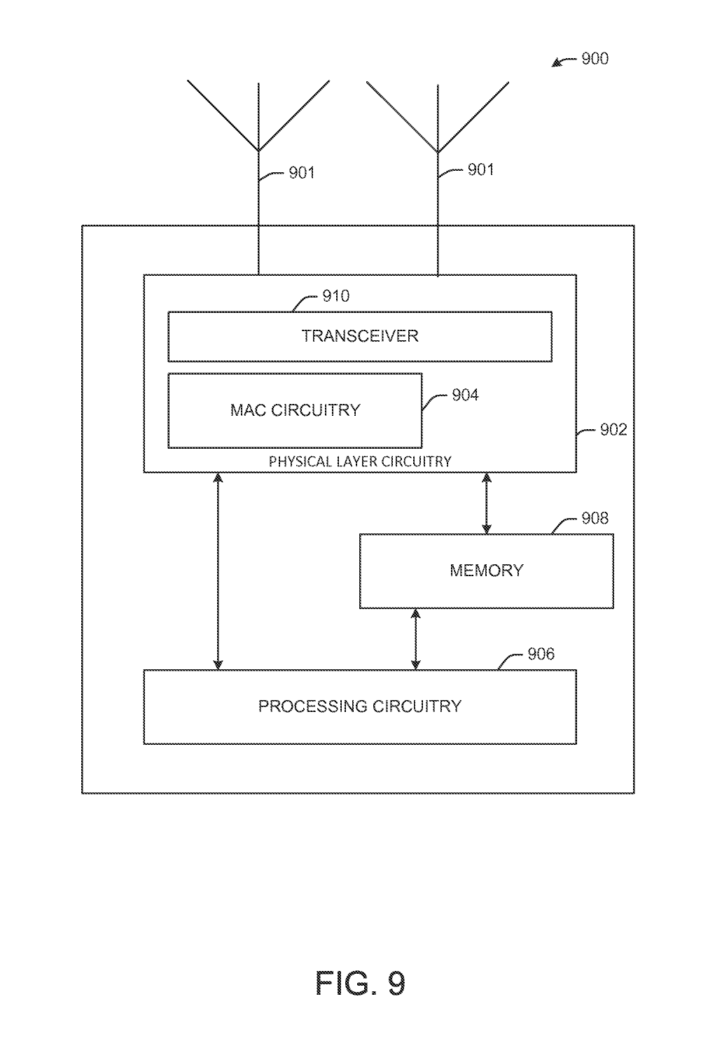

FIG. 9 shows a functional diagram of an exemplary communication station 900 in accordance with some embodiments. In one embodiment, FIG. 9 illustrates a functional block diagram of a communication station that may be suitable for use as an AP 110 (FIG. 1) or a wireless station 120 (FIG. 1) in accordance with some embodiments. In particular, the communication station 900 may be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 900 may include physical layer circuitry 902 having a transceiver 910 for transmitting and receiving signals to and from other communication stations using one or more antennas 901. The physical layer circuitry 902 may also include medium access control (MAC) circuitry 904 for controlling access to the wireless medium. The communication station 900 may also include processing circuitry 906 and memory 908 arranged to perform the operations described herein. In some embodiments, the physical layer circuitry 902 and the processing circuitry 906 may be configured to perform operations detailed in FIGS. 2-8.

In accordance with some embodiments, the MAC circuitry 904 may be arranged to contend for a wireless medium and configure frames or packets for communicating over the wireless medium and the physical layer circuitry 902 may be arranged to transmit and receive signals. The physical layer circuitry 902 may include circuitry for modulation/demodulation, upconversion/downconversion, filtering, amplification, etc. In some embodiments, the processing circuitry 906 of the communication station 900 may include one or more processors. In other embodiments, two or more antennas 901 may be coupled to the physical layer circuitry 902 arranged for sending and receiving signals. The memory 908 may store information for configuring the processing circuitry 906 to perform operations for configuring and transmitting message frames and performing the various operations described herein. The memory 908 may include any type of memory, including non-transitory memory, for storing information in a form readable by a machine (e.g., a computer). For example, the memory 908 may include a computer-readable storage device may, read-only memory (ROM), random-access memory (RAM), magnetic disk storage media, optical storage media, flash-memory devices and other storage devices and media.

In some embodiments, the communication station 900 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 900 may include one or more antennas 901. The antennas 901 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 900 may include one or more of a keyboard, a display, a non-volatile memory port, multiple antennas, a graphics processor, an application processor, speakers, and other mobile device elements. The display may be an LCD screen including a touch screen.

Although the communication station 900 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 900 may refer to one or more processes operating on one or more processing elements.

Certain embodiments may be implemented in one or a combination of hardware, firmware and software. Other embodiments may also be implemented as instructions stored on a computer-readable storage device, which may be read and executed by at least one processor to perform the operations described herein. The instructions may be in any suitable form, such as but not limited to source code, compiled code, interpreted code, executable code, static code, dynamic code, and the like. A computer-readable storage device or medium may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 900 may include one or more processors and may be configured with instructions stored on a computer-readable storage device memory.

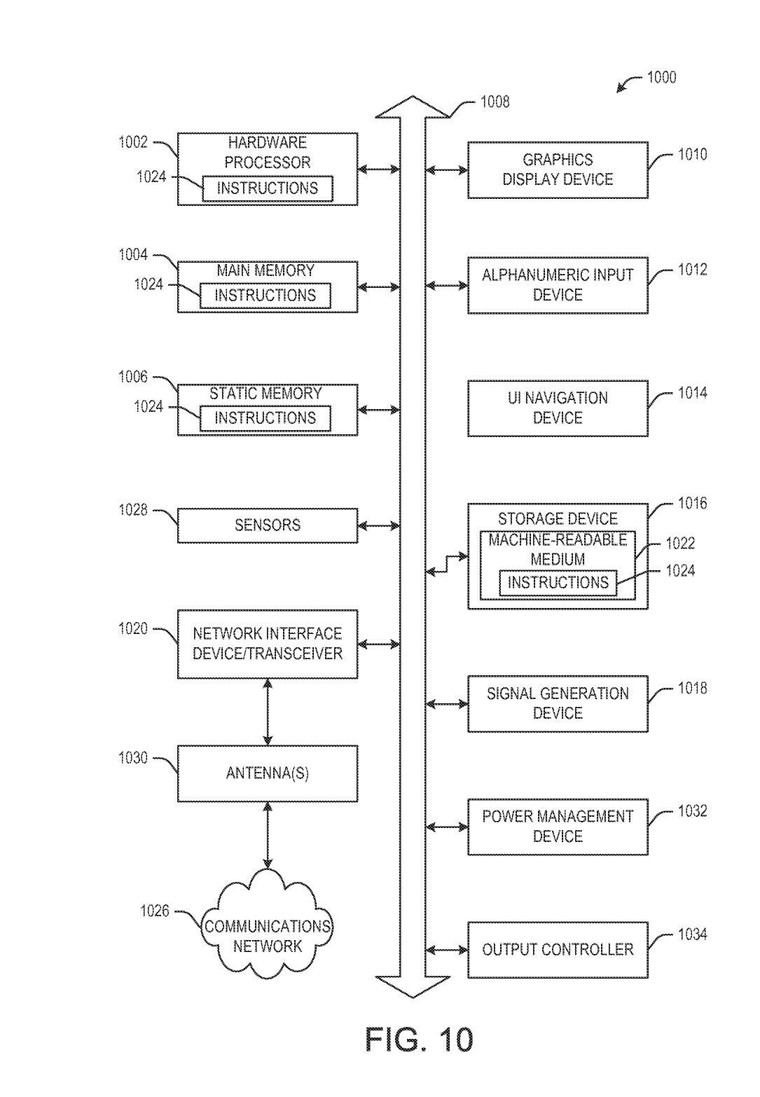

FIG. 10 illustrates a block diagram of an example of a machine 1000 or system upon which any one or more of the techniques (e.g., methodologies) discussed herein may be performed. In other embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environment. The machine 1000 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008. The machine 1000 may further include a power management device 1032, a graphics display device 1010, an alphanumeric input device 1012 (e.g., a keyboard), and a user interface (UI) navigation device 1014 (e.g., a mouse). In an example, the graphics display device 1010, alphanumeric input device 1012 and UI navigation device 1014 may be a touch screen display. The machine 1000 may additionally include a storage device (i.e., drive unit) 1016, a signal generation device 1018 (e.g., a speaker), a network interface device/transceiver 1020 coupled to antenna(s) 1030, and one or more sensors 1028, such as a global positioning system (GPS) sensor, compass, accelerometer, or other sensor. The machine 1000 may include an output controller 1034, such as a serial (e.g., universal serial bus (USB), parallel, or other wired or wireless (e g, infrared (IR), near field communication (NFC), etc.) connection to communicate with or control one or more peripheral devices (e.g., a printer, card reader, etc.)

The storage device 1016 may include a machine readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within the static memory 1006, or within the hardware processor 1002 during execution thereof by the machine 1000. In an example, one or any combination of the hardware processor 1002, the main memory 1004, the static memory 1006, or the storage device 1016 may constitute machine-readable media.

While the machine-readable medium 1022 is illustrated as a single medium, the term “machine readable medium” may include a single medium or multiple media (e.g., a centralized or distributed database, and/or associated caches and servers) configured to store the one or more instructions 1024.

The term “machine readable medium” may include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine-readable medium examples may include solid-state memories, and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium via the network interface device/transceiver 1020 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1020 may include one or more physical jacks (e.g., Ethernet, coaxial, or phone jacks) or one or more antennas to connect to the communications network 1026. In an example, the network interface device/transceiver 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1000, and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

According to example embodiments of the disclosure, there may be a device comprising: one or more processors; and one or more memory devices storing program instructions that are executable by the one or more processors to: select a frequency resource allocation index that allocates a first resource unit (RU) utilized in a narrow bandwidth transmission; and set a second RU in the frequency resource allocation index as non-allocated. In example embodiments, the transmission may be a high-efficiency signal field B (HE-SIG-B) communication. In still further example embodiments, the HE-SIG-B communication may include a HE-SIG-B1 and a HE-SIG-B2 communication, and the HE-SIG-B2 communication may allocate a 20 MHZ sub channel in instead of the HE-SIG-B1 communication allocating the 20 MHZ sub channel. In some further example embodiments, the allocated first RU may be at least 26 tones. In some further example embodiments, the non-allocated second RU may comprise a plurality of non-allocated RUs. In some further example embodiments, the plurality of non-allocated RUs are arranged contiguously in the frequency resource allocation index to mitigate frequency domain interference. In some further example embodiments, the plurality of non-allocated RUs are arranged non-contiguously in the frequency resource allocation index to mitigate frequency domain interference. In some further example embodiments, the device may include a radio and the radio may include one or more and antennas.

According to example embodiments of the disclosure, there may be a computer-readable non-transitory storage medium that contains instructions, which when executed by one or more processors result in performing operations comprising: selecting a frequency resource allocation index that allocates a first resource unit (RU) utilized in a narrow bandwidth transmission; and causing to set a second RU in the frequency resource allocation index as non-allocated. In example embodiments, the transmission may be a high-efficiency signal field B (HE-SIG-B) communication. In still further example embodiments, the HE-SIG-B communication may include a HE-SIG-B1 and a HE-SIG-B2 communication, and the HE-SIG-B2 communication may allocate a 20 MHZ sub channel in instead of the HE-SIG-B1 communication allocating the 20 MHZ sub channel. In some further example embodiments, the allocated first RU may be at least 26 tones. In some further example embodiments, the non-allocated second RU may comprise a plurality of non-allocated RUs. In some further example embodiments, the plurality of non-allocated RUs are arranged contiguously in the frequency resource allocation index to mitigate frequency domain interference. In some further example embodiments, the plurality of non-allocated RUs are arranged non-contiguously in the frequency resource allocation index to mitigate frequency domain interference.

According to example embodiments of the disclosure, there may be a device, comprising: one or more processors; and one or more memory devices storing program instructions that are executable by the one or more processors to: receive a stream index of a multiple-user multiple-input multiple-output (MU-MIMO) transmission, the stream index including a spatial stream indication for a station (STA) and an indication of a number of high-efficiency long training field (HE-LTF) symbols in a current PLCP Protocol Data Unit (PPDU). In further example embodiments, the indication of the number of HE-LTF symbols is optimized to save at least one signaling bit. In further example embodiments, the indication of the number of HE-LTF symbols is optimized by limiting a number of MU-MIMO user spatial streams to reduce signaling overhead. In some further example embodiments, the device may include a radio and the radio may include one or more and antennas.

According to example embodiments of the disclosure, there may be a computer-readable non-transitory storage medium that contains instructions, which when executed by one or more processors result in performing operations comprising: receiving a stream index of a multiple-user multiple-input multiple-output (MU-MIMO) transmission, the stream index including a spatial stream indication for a station (STA) and an indication of a number of high-efficiency long training field (HE-LTF) symbols in a current PLCP Protocol Data Unit (PPDU). In further example embodiments, the indication of the number of HE-LTF symbols is optimized to save at least one signaling bit. In further example embodiments, the indication of the number of HE-LTF symbols is optimized by limiting a number of MU-MIMO user spatial streams to reduce signaling overhead.

According to example embodiments of the disclosure, there may be a method. The method may include selecting a frequency resource allocation index that allocates a first resource unit (RU) utilized in a narrow bandwidth transmission; and setting a second RU in the frequency resource allocation index as non-allocated. In example embodiments, the transmission may be a high-efficiency signal field B (HE-SIG-B) communication. In still further example embodiments, the HE-SIG-B communication may include a HE-SIG-B1 and a HE-SIG-B2 communication, and the HE-SIG-B2 communication may allocate a 20 MHZ sub channel in instead of the HE-SIG-B1 communication allocating the 20 MHZ sub channel. In some further example embodiments, the allocated first RU may be at least 26 tones. In some further example embodiments, the non-allocated second RU may comprise a plurality of non-allocated RUs. In some further example embodiments, the plurality of non-allocated RUs are arranged contiguously in the frequency resource allocation index to mitigate frequency domain interference. In some further example embodiments, the plurality of non-allocated RUs are arranged non-contiguously in the frequency resource allocation index to mitigate frequency domain interference.

According to example embodiments of the disclosure, there may be a method. The method may include receiving a stream index of a multiple-user multiple-input multiple-output (MU-MIMO) transmission, the stream index including a spatial stream indication for a station (STA) and an indication of a number of high-efficiency long training field (HE-LTF) symbols in a current PLCP Protocol Data Unit (PPDU). In further example embodiments, the indication of the number of HE-LTF symbols is optimized to save at least one signaling bit. In further example embodiments, the indication of the number of HE-LTF symbols is optimized by limiting a number of MU-MIMO user spatial streams to reduce signaling overhead.

According to example embodiments of the disclosure, there may be a means for selecting a frequency resource allocation index that allocates a first resource unit (RU) utilized in a narrow bandwidth transmission; and means for setting a second RU in the frequency resource allocation index as non-allocated. In example embodiments, the transmission may be a high-efficiency signal field B (HE-SIG-B) communication. In still further example embodiments, the HE-SIG-B communication may include a HE-SIG-B1 and a HE-SIG-B2 communication, and the HE-SIG-B2 communication may allocate a 20 MHZ sub channel in instead of the HE-SIG-B1 communication allocating the 20 MHZ sub channel. In some further example embodiments, the allocated first RU may be at least 26 tones. In some further example embodiments, the non-allocated second RU may comprise a plurality of non-allocated RUs. In some further example embodiments, the plurality of non-allocated RUs are arranged contiguously in the frequency resource allocation index to mitigate frequency domain interference. In some further example embodiments, the plurality of non-allocated RUs are arranged non-contiguously in the frequency resource allocation index to mitigate frequency domain interference.

According to example embodiments of the disclosure, there may be a means for receiving a stream index of a multiple-user multiple-input multiple-output (MU-MIMO) transmission, the stream index including a spatial stream indication for a station (STA) and an indication of a number of high-efficiency long training field (HE-LTF) symbols in a current PLCP Protocol Data Unit (PPDU). In further example embodiments, the indication of the number of HE-LTF symbols is optimized to save at least one signaling bit. In further example embodiments, the indication of the number of HE-LTF symbols is optimized by limiting a number of MU-MIMO user spatial streams to reduce signaling overhead.

What is claimed is:

1. A device, comprising:
one or more processors; and
one or more memory devices storing program instructions that are executable by the one or more processors to:
select a frequency resource allocation index that allocates a first resource unit (RU) utilized in a narrow bandwidth transmission; and
set at second RU in the frequency resource allocation as non-allocated.

2. The device of claim 1, wherein the transmission comprises a high-efficiency signal field B (HE-SIG-B) communication.

3. The device of claim 2, wherein the HE-SIG-B communication comprises a HE-SIG-B1 communication and a HE-SIG-B2 communication, wherein the HE-SIG-B2 communication allocates a 20 MHZ sub channel in instead of the HE-SIG-B1 communication allocating the 20 MHZ sub channel.

4. The device of claim 1, wherein the allocated first RU comprises at least 26 tones.

5. The device of claim 1, wherein the non-allocated second RU comprises a plurality of non-allocated RUs.

6. The device of claim 5, wherein the plurality of non-allocated RUs are arranged contiguously in the frequency resource allocation to mitigate frequency domain interference.

7. The device of claim 5, wherein the plurality of non-allocated RUs are arranged non-contiguously in the frequency resource allocation to mitigate frequency domain interference.

8. The device of claim 1, further comprising a radio.

9. The device of claim 8, wherein the radio comprises one or more antennas.

10. A computer-readable non-transitory storage medium that contains instructions, which when executed by one or more processors result in performing operations comprising:
selecting a frequency resource allocation index that allocates a first resource unit (RU) utilized in a narrow bandwidth transmission; and
causing to set a second RU in the frequency resource allocation as non-allocated.

11. The medium of claim 10, wherein the transmission comprises a high-efficiency signal field B (HE-SIG-B) communication.

12. The medium of claim 11, wherein the HE-SIG-B communication comprises a HE-SIG-B1 communication and a HE-SIG-B2 communication, wherein the HE-SIG-B2 communication allocates a 20 MHZ sub channel in instead of the HE-SIG-B1 communication allocating the 20 MHZ sub channel.

13. The medium of claim 10, wherein the allocated first RU comprises at least 26 tones.

14. The medium of claim 10, wherein the non-allocated second RU comprises a plurality of non-allocated RUs.

15. The medium of claim 14, wherein the plurality of non-allocated RUs are arranged contiguously in the frequency resource allocation index to mitigate frequency domain interference.

16. The medium of claim 14, wherein the plurality of non-allocated RUs are arranged non-contiguously in the frequency resource allocation index to mitigate frequency domain interference.

17. A device, comprising:
one or more processors; and
one or more memory devices storing program instructions that are executable by the one or more processors to:
receive a stream index of a multiple-user multiple-input multiple-output (MU-MIMO) transmission, the stream index including a spatial stream indication for a station (STA) and an indication of a number of high-efficiency long training field (HE-LTF) symbols in a current PLCP Protocol Data Unit (PPDU).

18. The device of claim 17, further comprising a radio.

19. The device of claim 18, wherein the radio comprises one or more antennas.

20. The device of claim 17, wherein the indication of the number of HE-LTF symbols is optimized to save at least one signaling bit.

21. The device of claim 20, wherein the indication of the number of HE-LTF symbols is optimized by limiting a number of MU-MIMO user spatial streams to reduce signaling overhead.

22. A computer-readable non-transitory storage medium that contains instructions, which when executed by one or more processors result in performing operations comprising:
receiving a stream index of a multiple-user multiple-input multiple-output (MU-MIMO) transmission, the stream index including a spatial stream indication for a station (STA) and an indication of a number of high-efficiency long training field (HE-LTF) symbols in a current PLCP Protocol Data Unit (PPDU).

23. The medium of claim 22, wherein the indication of the number of HE-LTF symbols is optimized to save at least one signaling bit.

24. The medium of claim 23, wherein the indication of the number of HE-LTF symbols is optimized by limiting a number of MU-MIMO user spatial streams to reduce signaling overhead.
